(19) United States
(12) Patent Application Publication
(10) Pub. No.: US 2009/0189779 A1
(43) Pub. Date: Jul. 30, 2009

(54) Automatic garage door closing through the vehicle control

(75) Inventor: Jiyong Gao, Northville, MI (US)

Correspondence Address: HARNESS, DICKEY & PIERCE, P.L.C., P.O. BOX 828, BLOOMFIELD HILLS, MI, 48303, US

(73) Assignee: DENSO International America, Inc., Southfield, MI (US)

(21) Appl. No.: 12/011,362

(22) Filed: Jan. 25, 2008

(51) Int. Cl. G08C 17/00

(52) U.S. Cl. 340/901

(57) ABSTRACT

A method of controlling a garage door of a garage may entail detecting an open condition of the garage door using a sensor within the garage, transmitting a garage door open signal from the sensor to a communication unit in the garage; transmitting an alert signal from the communication unit in the garage to a control module within a vehicle; determining a level of ambient light from an ambient light sensor; transmitting a signal from the ambient light sensor to the control module indicative of the level of ambient light; transmitting a door close signal from the control module to the transmitter in the vehicle; transmitting the door close signal from the transmitter in the vehicle to the communication unit in the garage; and closing the garage door with a motor upon the garage door actuation module receiving the close door signal.

### FIELD

The present disclosure relates to a garage door actuation system, and in one aspect, to an automatic garage door actuation system controlled through vehicle controls.

### BACKGROUND

The statements in this section merely provide background information related to the present disclosure and may not constitute prior art. Modern automobile garages may include an electrically powered garage door opener. Typically, such garage door openers include a hardwired switch inside the garage to operate or actuate the opener, that is, raise and lower the garage door. Additionally, the garage door opener may employ one or more remote switches operable to actuate the garage door opener remotely from a vehicle, for example.

Typically, a person must manually actuate either the hardwired switch or the remote switch. People commonly forget to close their garage doors at night, and often do not realize this until the following day, thereby leaving their garage door open an entire night.

### SUMMARY

A garage door control system includes an actuation module operable to actuate a garage door and a control module in communication with the actuation module. The control module controls the actuation module based on at least one of an ambient light level, a time condition, and an alert signal from the actuation module.

An algorithm for a control module of a garage door control system includes receiving an alert signal from a garage door actuation module indicating a garage door is open, receiving a signal indicating satisfaction of an ambient light condition, receiving a signal indicating satisfaction of a time condition, and communicating a close signal to the garage door actuation module to close the garage door.

Further areas of applicability will become apparent from the following detailed description. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a vehicle and a garage including a garage door actuation system according to the principles of the present disclosure;

FIG. 2 is a block diagram of a control system and an actuation module according to the principles of the present disclosure;

FIG. 3 is a flowchart of an algorithm for controlling the garage door control system according to the principles of the present disclosure;

FIG. 4 is a flowchart of an algorithm for controlling the garage door control system according to an alternative embodiment of the present disclosure;

FIG. 5 is a flowchart of an algorithm for controlling the garage door control system according to yet another embodiment of the present disclosure; and

FIG. 6 is a flowchart of an algorithm for controlling the garage door control system according to still another embodiment of the present disclosure.

### DETAILED DESCRIPTION

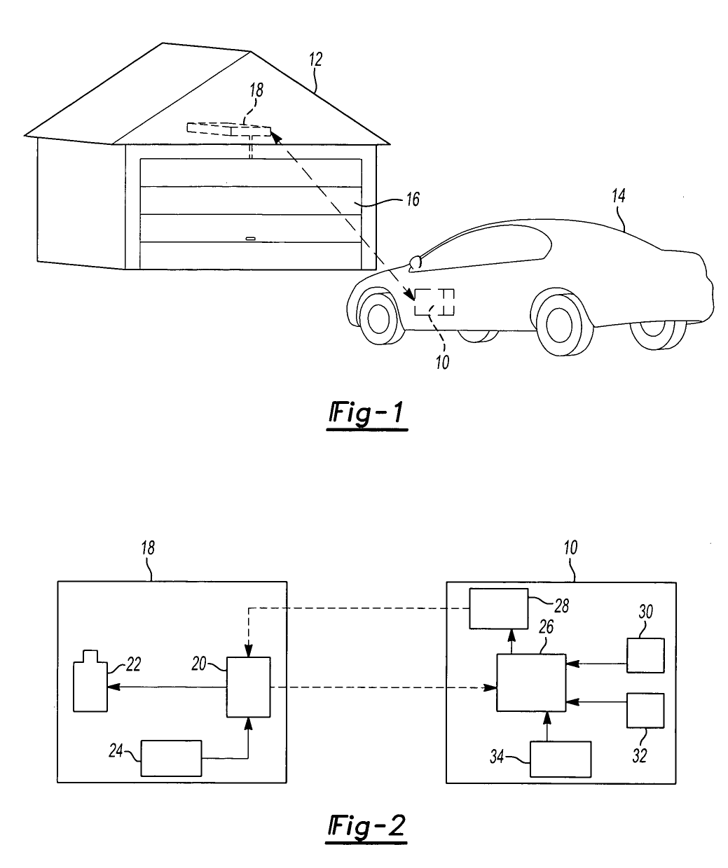

The following description is merely exemplary in nature and is not intended to limit the present disclosure, application, or uses. It should be understood that throughout the drawings, corresponding reference numerals indicate like or corresponding parts and features. With reference to FIGS. 1-6, a garage door control system will be described. The garage door control system is operable to remotely actuate a garage door. The garage door control system may be disposed on a vehicle and may operate without user interaction.

FIG. 1 depicts a garage door control system 10 (or control system), which may be installed in a vehicle 14, and a garage 12. The garage 12 may include a garage door 16 and a garage door actuation module 18 (actuation module). The actuation module 18 is mechanically linked to the garage door 16, such as with a chain or belt, and may be operable to open and/or close the garage door 16. The control system 10 may be in wireless communication with the actuation module 18, and may be operable to cause the actuation module 18 to remotely open and/or close the garage door 16 without user interaction, as will be subsequently described.

It should be appreciated that the control system 10 is not limited to installation in the vehicle 14. In alternative embodiments, the control system 10 may be installed inside (in) or outside (on) the garage 12, a house or other building, or any other location in the proximity of the garage 12.

Referring now to FIG. 2, a block diagram depicts the flow of logic or communications of the control system 10 and the actuation module 18 and between the control system 10 and actuation module 18. The actuation module 18 may include a communication unit 20, a motor 22, and a sensor 24. The control system 10 includes a control module 26 and a transmitter 28, and may include an ambient light sensor 30, a clock 32, and a user input module 34.

The communication unit 20 of the actuation module 18 is in communication with the control system 10 and is adapted to transmit and receive wireless signals such as radio frequency waves or other suitable light signals such as visible or non-visible signals (e.g. infrared signals). The communication unit 20 may be operable to receive a close signal from the transmitter 28, under circumstances which will be subsequently described, which causes the motor 22 to close the garage door 16. The motor 22 may be any of the electro-mechanical devices known in the art to be suitable for opening and closing a garage door 16 using a belt or chain, as examples.

The sensor 24 may be adapted to detect an open position of the garage door 16, and furthermore, the sensor 24 may be adapted to optically detect (e.g. an optical sensor) the presence or absence of the garage door 16 in its closed position to determine if the garage door 16 is in a closed or open position. It should be appreciated that the sensor 24 is not limited to optical sensors, in certain instances known as an electric eyes, and may include any suitable sensor known in the art operable to detect the position of a garage door, such as a mechanical (as opposed to optical) switch to detect door position.

The sensor 24 is in communication with the communication unit 20. When the sensor 24 detects the garage door 16 is in an open position, the communication unit 20 may wirelessly transmit an alert signal to the control module 26 indicating the open position of the garage door 16. While the garage door 16 is in the open position, the communication unit 20 may transmit the alert signal continuously or intermittently, such as at a timed interval.

The ambient light sensor 30 is adapted to sense and quantify the level of ambient light (as is known in the art) outside the vehicle 14 and communicate this data to the control module 26. The ambient light sensor 30 may then communicate a level of ambient light in the proximity of the ambient light sensor 30 to the control module 26. Such communication between the ambient light sensor 30 and the control module 26 may be continuous or intermittent, such as at a timed interval. The ambient light sensor 30 may be hardwired to communicate with the control module 26. Alternatively, the ambient light sensor 30 may be adapted for wireless communication with the control module 26.

The ambient light sensor 30 may be mounted in any suitable location inside or outside of the vehicle 14 where there is a clear line of sight to ambient light outside of the vehicle 14. The ambient light sensor 30 may also be used with an automatic activation system for external lights (not shown; known in the art) of the vehicle 14, including headlights, for example. That is, the ambient light sensor 30, when mounted in or on the vehicle 14, may also serve as the sensor that activates and deactivates external lights of the vehicle based upon the amount of ambient light outside of the vehicle.

The clock 32 is operable to track a time of day and night, as is known in the art, and communicate the time to the control module 26, either continuously or intermittently. The clock 32 may also be operable to track an elapsed time since the last close signal was sent by the transmitter 28 to the actuation module 18. The clock 32 may be mounted to the vehicle 14 in any location suited to facilitate the function of the clock 32. Communication between the clock 32 and the control module 26 may be wireless or by hard wire.

The user input module 34 may be in communication with the control module 26. The user input module 34 may be disposed in the interior of the vehicle 14, on an instrument panel (not shown), for example, or any other suitable location where it is accessible to a user, who may be an occupant of the vehicle 14. The user input module 34 may be operable to allow the user to customize, disable, and/or override a control algorithm of the control module 26, that is customize, disable, and/or override the control module 26 itself.

The transmitter 28 of the control system 10 may be disposed in or on the vehicle 14. The transmitter 28 may communicate by wire or wirelessly with the control module 26. The control module 26 is adapted to cause the transmitter 28 to send a close signal (via radio frequency waves or other suitable light or frequency signals) to the actuation module 18 under circumstances which will be subsequently described.

As described above, the control module 26 is adapted to receive data from the communication unit 20 of the actuation module 18, the ambient light sensor 30, the clock 32, and the user input module 34. Based on the received data, the control module 26 may cause the transmitter 28 to wirelessly transmit the close signal to the actuation module 18, which then closes the garage door 16 by invoking the motor 22 to drive the garage door to a closed position.

FIG. 3 depicts a control algorithm, which is performed by the control module 26, which will now be described. As shown in the flowchart of FIG. 3, at decision block 100, the control module 26 first determines whether it has received the alert signal from the communication unit 20 of the actuation module 18 indicating that the garage door 16 is open. If the alert signal has not been received, the control algorithm resets, or returns to start, and the control module 26 checks again for the alert signal. Checking for the alert signal may occur continuously or intermittently at some timed interval until the alert signal is received. By way of the user input module 34, the user or manufacturer of the control module 26 may customize the frequency with which the control module 26 checks for the alert signal from the communication unit 20.

If the reply is “yes” at decision block 100, and the alert signal has been received from the actuation module 18, the control module 26 checks ambient light data (e.g. the light level or data indicative of the light level) received from the ambient light sensor 30 when the flow of logic reaches decision block 110. If the ambient light level is not within a predetermined range, the control algorithm resets, as shown in FIG. 3. This predetermined range of ambient light may be customized via the user input module 34.

If the ambient light condition is satisfied at decision block 110, that is, the ambient light level is within the predetermined range, then the flow continues and the control module 26 checks for time data received from the clock 32 at decision block 120. The control module 26 may be in continuous communication with the clock 32 and may receive data indicating the time of day or night, the amount of time since the garage door 16 was last opened, and/or the amount of time since the transmitter 28 last sent the close signal. If the control module 26 determines that a time condition is not satisfied, the control algorithm will reset, as shown in FIG. 3. Satisfaction of the time condition may require satisfaction of any or all of several parameters including whether the time of day or night is within a predetermined time range, whether the time since the garage door 16 was last opened is within a predetermined time range, and/or whether the time since the transmitter 28 last sent the close signal to the communication unit 20 of the actuation module 18, is within a predetermined time range. The user input module 34 may be operable to enable the user to manually select which of these parameters will form the basis of the time condition so that a determination may be made at decision block 120. The time ranges of the above parameters may be customized by the user via the user input module 34.

If the time condition is satisfied, the flow of logic will continue to block 130 where the control module 26 will send a signal to the transmitter 28 causing the transmitter 28 to wirelessly transmit a close signal to the communication unit 20 of the actuation module 18. The close signal will cause the motor 22 of the actuation module 18 to close the garage door 16.

Continuing with FIG. 3, upon exiting block 130, the control logic flows to block 140 where the time since a close signal is sent begins to be kept track of, or recorded. Keeping track of or recording the elapsed time since a close signal is sent may be stored in a memory, for example, although such may not be necessary. Upon exiting block 140, the flow logic enters decision block 150 where an inquiry is made as to whether the elapsed time condition is satisfied. If the result of such an inquiry is “no,” then the control loops, or continues to make the same inquiry at block 150, as to whether the elapsed time condition is satisfied. When the elapsed time condition is satisfied, that is, if a “yes” is returned, the control algorithm will then check for an alert signal. Upon flowing through all logic blocks 100-150 of FIG. 3, one is assured that the garage door 16 closes in response to the close signal after a predetermined amount of time after the close signal is transmitted. Satisfaction of the elapsed time condition at decision block 150 may require the passage of a predetermined amount of time from when the transmitter 28 sends a close signal to the actuation module 18. As described above, any or all of the parameters, including the alert signal transmission, the ambient light condition, the time conditions, and the elapsed time condition may be customized, overridden, or disabled via the user input module 34.

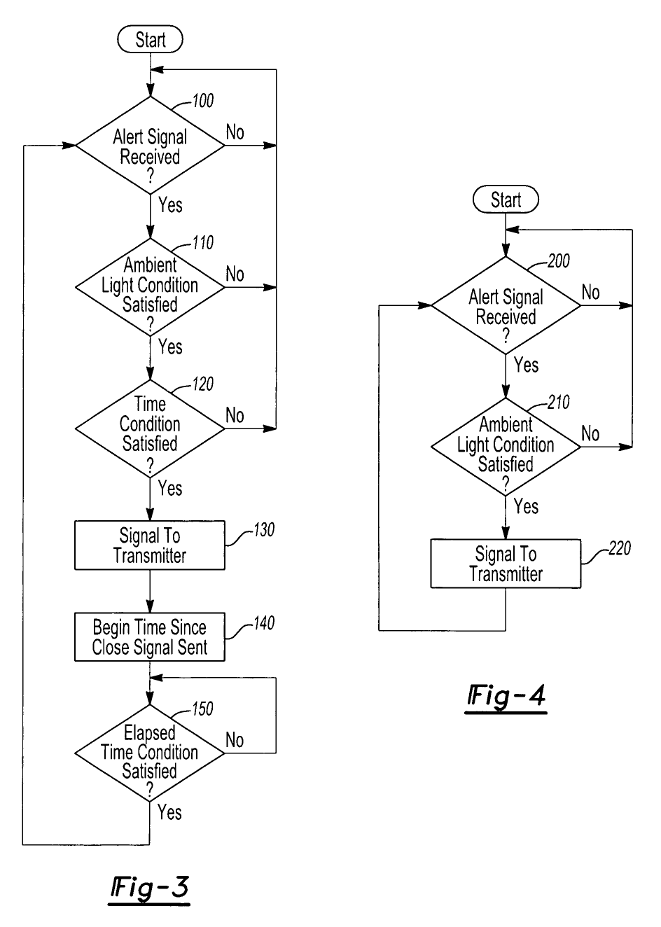

FIG. 4 depicts a flowchart of an alternative embodiment of the control algorithm. As depicted in decision block 200, the routine checks for an alert signal. That is, the control module 26 first determines whether it has received the alert signal from the communication unit 20 of the actuation module 18 thus indicating that the garage door 16 is open. If there is no alert signal, the garage door is likely closed. If no alert signal has been received, the control begins anew, or is reset, such that the routine again checks for an alert signal. If an alert signal has been received in decision block 200, that is, a “yes” response is returned, then control proceeds to decision block 210 where the logic checks to see if the ambient light condition, as sensed by the ambient light sensor 30 has been satisfied. If the ambient light condition has not been satisfied, that is, a “no” response has been returned, then the control is reset, or that is, the routine begins anew by entering decision block 200. If the ambient light condition is satisfied, that is, a “yes” is returned, then, upon proceeding to block 220, the control module 26 signals the transmitter 28 to send the close signal to the communication unit 20 to close the garage door 16, such as by using the motor 22.

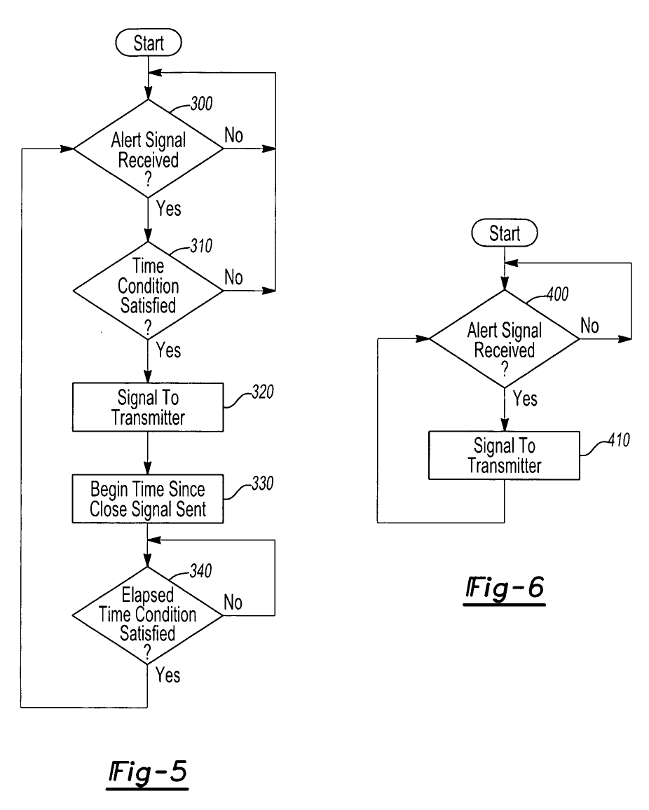

FIG. 5 depicts a flowchart of yet another logical flow embodiment of a control algorithm. As depicted, the control module 26 signals the transmitter 28 to send the close signal based on receipt of the alert signal from the actuation module 18 and satisfaction of the time condition. In this embodiment, the control module 26 will check again for the alert signal after satisfaction of the elapsed time condition. More specifically, upon starting of the routine and proceeding to decision block 300, the logic decides whether an alert signal has or has not been received. That is, the control module 26 first determines whether it has received the alert signal from the communication unit 20 of the actuation module 18 indicating that the garage door 16 is open. If no alert signal has been received, then the control returns to decision block 300. If an alert signal has been received, then the decision block 300 returns a “yes” and the control logic proceeds to decision block 310. In decision block 310, the control logic determines whether a time condition has been satisfied. That is, the flow continues and the control module 26 checks time data received from the clock 32 at decision block 310. The control module 26 may be in continuous communication with the clock 32 and may receive data indicating the time of day or night, the amount of time since the garage door 16 was last opened, and/or the amount of time since the transmitter 28 last sent the close signal. If the control module 26 determines that a time condition is not satisfied, the control algorithm will reset, as depicted in FIG. 5. If a time condition is satisfied, then the flow continues to block 320, where a signal is sent from the control module 26 to the transmitter 28, causing the transmitter 28 to wirelessly transmit a close signal to the communication unit 20 of the actuation module 18. The close signal will cause the motor 22 of the actuation module 18 to close the garage door 16.

Continuing with FIG. 5, the flow continues to block 330, where the elapsed time since the close signal being sent from the transmitter 28 to he communication unit 20 is kept track of, or recorded. Such elapsed time may or may not be recorded in a memory. The flow then proceeds to block 340 which enquires as to whether an elapsed time condition is satisfied or not. When the elapsed time condition is satisfied, the garage door can be considered to be completely closed. If the elapsed time condition is not satisfied, that is, a “no” results upon inquiry, then the flow loops, or again enters the decision block 340. However, if an elapsed time condition is satisfied, that is, a “yes” decision results, then the flow again proceeds to inquiry block 300 where the control module 26 again determines whether it has received the alert signal from the communication unit 20 of the actuation module 18 indicating whether the garage door 16 is, once again, open.

Upon flowing through all logic blocks 300-340 of FIG. 5, one is assured that the garage door 16 closes in response to the close signal after a predetermined amount of time after the close signal is transmitted. Satisfaction of the elapsed time condition at decision block 340 may require the passage of a predetermined amount of time from when the transmitter 28 sends a close signal to the actuation module 18. As described above, any or all of the parameters, including the alert signal transmission, the time conditions, and the elapsed time condition may be customized, overridden, or disabled via the user input module 34.

FIG. 6 depicts a flowchart of still another embodiment of the control algorithm in which the control module 26 causes or signals the transmitter 28 to send the close signal to the communication unit 20, as represented by block 410, based only on receipt of the alert signal from the actuation module 18 into the control module 26. Upon confirmation of the receipt (“yes”) of the alert signal, as represented by block 400, the logic proceeds to block 410 where the aforementioned alert signal communication involving the control module 26, transmitter 28, and communication unit 20 occurs. In this embodiment, the actuation module 18 may only transmit an alert signal intermittently, at predetermined time intervals programmed via the user interface module 34.

Those skilled in the art may appreciate that the control system 10 may control the actuation module 18 based upon any one of the parameters described above, including the ambient light condition, time condition, such as the time of day condition or elapsed time condition, and position of the garage door 16, or any combination thereof. The control system 10 and the actuation module 18 may operate without interaction with a user; however, a user may manually open or close the garage door 16 via the user input module 34, a hardwired actuation switch inside or outside of the garage (not shown but known in the art), and/or a conventional remote control unit (not shown, but known in the art).

Those skilled in the art may also appreciate that the operation of the control system 10 does not require the engine (not shown) of the vehicle 14 to run, nor does the vehicle 14 need to have its accessory mode, such as may be within a vehicle ignition system, turned on or activated (as is known in the art to be required with some electrically powered systems within a vehicle). In an embodiment such that the control system 10 is installed in the vehicle 14, one of ordinary skill in the art will appreciate that the control system 10 may solely operate from on-board battery power of the vehicle 14.

Continuing with the above disclosure, a garage door control system 10 may utilize an actuation module 18 within a garage 12, the actuation module 18 may be operable to actuate, (e.g. raise and lower) a garage door 16, The system may also utilize a control module 26 within a vehicle 14, the control module 26 may be in wireless communication with the actuation module 18 within the garage 12 to control the actuation module 18, the control may be based on at least one of an ambient light level, a time condition, and an alert signal from the actuation module 18. The control module 26 may control the actuation module 18 based on the ambient light level sensed by a sensor 30 and the time condition sensed or governed by a clock 32. The control module 26 may be adapted (e.g. generate a signal channeled through a transmitter) to cause the actuation module 18 to close the garage door 16.

The actuation module 18 may further utilize a communication unit 20 and an optical sensor 24 such that the communication unit 20 is adapted (configured) to wirelessly communicate data to the control module 26, the control module 26 acquiring data from the optical sensor 24. The optical sensor 24 may be in communication with the actuation module 18, and the optical sensor 24 may be adapted (configured) to detect an open position of the garage door 16. The control module 26 may be operable to cause a transmitter 28 to wirelessly communicate with the actuation module 18. The transmitter 28 may be operable to cause the actuation module 18 to close the garage door 16.

The garage door control system 10 may further utilize a user input module 34 such that the user input module may be adapted (i.e. configured) to receive input from a user and communicate such input to the control module 26. An ambient light sensor 30 mounted to the vehicle may sense the ambient light level and communicate the level to the control module 26 and then ultimately to the actuation module 18, such as through a transmitter 28, for example. Still yet, the garage door control system 10 may utilize a sensor 24 (door open sensor) within the actuation module 18 such that the actuation module 18 is adapted to send an alert signal to the control module 26 when the door open sensor 24 senses an open garage door. The control module 26 may be adapted to receive the alert signal, which indicates that the garage door 16 is open.

In yet another example, a garage door control system 10 for closing a garage door 16 may utilize a transmitter 28 mounted to a vehicle 14, a control module 26 mounted to the vehicle 14 and in communication with the transmitter 28, and an ambient light sensor 30 mounted to the vehicle 14 and in communication with the control module 26. The control module 26 may control the transmitter 28 based at least on data (e.g. sensed light level) received from the ambient light sensor 30. The garage door control system 10 for a vehicle may further utilize a garage door actuation module 18 such that the control module 26 is operable to cause the transmitter 28 to transmit a close signal to the garage door actuation module 18 to cause the garage door 16 to close upon receipt of the close signal by the garage door actuation module 18. The garage door control system for a vehicle may further utilize a garage door actuation module 18 such that the garage door actuation module 18 is in wireless communication with the control module 26. The garage door actuation module 18 may possess the capability to detect an open position of the garage door 16 by using a sensor 24. The control module 26 may be operable to receive an alert signal from the communication unit 20 that indicates an open position of the garage door 16. The control module 26 may control or signal the transmitter 28 based on receipt of the alert signal from the communication unit 20.

In another example, a garage door control system 10 to close a garage door 16 may utilize a transmitter 28 mounted to a vehicle 14, a control module 26 mounted to the vehicle that is in communication with the transmitter 28, and a clock 32 mounted to the vehicle and in communication with the control module 26 such that the control module 26 controls the transmitter 28 based at least on time data received from the clock 32. The control module 26 may control the transmitter 28 based on data, such as the level of ambient light detected, received from the ambient light sensor 30. A garage door actuation module 18 may be mounted within a vehicle garage 16 such that the control module 26 is operable to cause the transmitter 28 to wirelessly communicate with the garage door actuation module 18 and cause the garage door actuation module 18 to effectuate a close condition of the garage door 16. Still yet, the garage door system 10 for a vehicle may utilize a garage door actuation module 18 and a sensor 24 such that the sensor 24 is capable of either mechanically detecting or optically detecting an open garage door condition and communicate the open garage door condition to the garage door actuation module 18, and more specifically, communicate the open garage door condition to the communication unit 20. The system may also utilize a communication unit 20 mounted within the garage such that the control module 26 is operable to receive, from the communication unit 20, an alert signal indicating a garage door 16 is open while the control module 26 is operable to control or signal to the transmitter 28 based on receipt of the alert signal.

A control method for a control module 26 of a garage door control system 10 may entail: receiving, in the vehicle control module 26, an alert signal from a garage door actuation module 18, the alert signal indicating an open condition of a garage door 16; receiving, in the vehicle control module 26, a signal indicating an ambient light condition relative to (e.g. below or above) a threshold light condition; receiving, in the vehicle control module 26, a signal indicating attainment of a condition relative to time; and communicating, from the vehicle control module 26, a door close signal to the garage door actuation module 18 to close the garage door 16. The garage door 16 will be closed only if parameters or threshold requirements of the light and time conditions are met. Alternatively, such parameters or threshold requirements of the light and time conditions do not have to be met, and in such a case, the user input module 34 may be programmed by a user to permit the control module 26 to act without such light and time conditions being met.

Still yet, a method of controlling a garage door 16 of a garage 12 may entail detecting an open condition of the garage door 16 using a garage door actuation module 18 located inside the garage 12, transmitting an alert signal from the garage door actuation module 18 within the garage 12 to a garage door control system 10 within a vehicle 14, transmitting a signal from the garage door control system 10 within the vehicle 14 to the garage door actuation module 18 in the garage 12, and closing the garage door 16 upon the garage door actuation module 18 receiving the close door signal. Detecting an open condition of the garage door 16 may be accomplished using an optical sensor 24 or alternatively, a mechanical sensor 24 (e.g. a mechanical switch 24) that may undergo a switching operation as the garage door 16 is raised or lowered. Transmitting a signal from the garage door control system 10 within the vehicle 14 to the garage door actuation module 18 within the garage 12 may entail sensing an ambient light level outside of the vehicle 14 with an ambient light sensor 30 within the vehicle 14, and then determining that the ambient light level is less than a threshold level (i.e. the light level outside is less than the threshold light level) before transmitting a signal from the garage door control system 10 within the vehicle 14 to the garage door actuation module 18 to cause closing of the garage door 16.

Continuing, transmitting a signal from the garage door control system 10 within the vehicle 14 to the garage door actuation module 18 within the garage 12 may further entail determining that a time of day is within a predetermined range of time before transmitting a signal from the garage door control system 10 within the vehicle 14 to the garage door actuation module 18 to close the garage door 16 using a motor 22. Another determination may be used in addition to or as an alternative to the preceding determination based on a range of time. For instance, determining whether an elapsed amount of time has passed since the garage door was last opened may be made and based upon the answer (the elapsed time) to such an inquiry, the control module 26 may or may not require closing of the garage door 16. Any decision to close the garage door would be based upon the garage door actuation module 18 receiving a close door signal from the transmitter 28 of the garage door control system 10 based upon such elapsed time inquiry.

A method of controlling (e.g. opening and closing) a garage door 16 of a garage 12 may also entail detecting an open condition of the garage door 16 using a sensor 24, transmitting a first signal indicative of, and in response to, the open condition of the garage door 16 to a communication unit in the garage 12, transmitting a door open signal from the communication unit 20 in the garage 12 to a control module 26 in a vehicle 14, transmitting the door close signal from a control module 26 in the vehicle 14 to a transmitter 28 in the vehicle 14, transmitting the close door signal from the transmitter 28 in the vehicle 14 to the communication unit 20 in the garage 12, and closing the garage door 16 with a motor 22 in the garage 12.

Continuing, before transmitting the door close signal from the control module 26 in the vehicle 14 to a transmitter 28 in the vehicle 14, an ambient light level outside of the vehicle may be measured by an ambient light sensor 30 in the vehicle 14 or on an exterior of the vehicle. The ambient level outside of the vehicle is below a predetermined light level then the control module 26 may permit the close door signal to be sent from the control module 26 to the transmitter 28 and subsequently the communication unit 20. Thus, determining the ambient level of light by the ambient light sensor 30 may be another method step in closing the garage door 16.

Still yet, before transmitting the door close signal from the control module 26 in the vehicle to a transmitter 28 in the vehicle, determining, with a clock 32 or time measuring device 32, whether a current time of day is during daylight hours or non-daylight hours may occur. The result of such an inquiry may also permit or not permit the control module 26 to send a close door signal to the transmitter 28 and subsequently the communication unit 20. Moreover, before transmitting the door close signal from the control module 26 in the vehicle to a transmitter 28 in the vehicle, determining, with a clock 32 or time measuring device 32, an amount of time since the garage door 16 was last opened may occur. The result of such an inquiry may also permit or not permit the control module 26 to send a close door signal to the transmitter 28 and subsequently the communication unit 20.

In line with the same decision making inquiries for the control module 26, before transmitting the door close signal from the control module 26 in the vehicle to a transmitter 28 in the vehicle, the method may entail determining, with a clock 32 or time measuring device 32, whether an amount of time since the transmitter last sent a garage door close signal to the communication unit 20 is within a predetermined time range or above a threshold value (e.g. above 24 hours). The result of such an inquiry may also permit or not permit the control module 26 to send a close door signal to the transmitter 28 and subsequently the communication unit 20 to close the garage door 16.

A user input module 34 within the vehicle may be used for controlling which of the above-discussed parameters or decision criteria are actually used by the control module 26 to send a close door signal to the transmitter 28 and communication unit 20. The user input module 34 may be programmed by human programming, such as with a key pad within the vehicle and effectively result in customized control of the control module 26 and thus, closing of the garage door 16.

Another method of controlling a garage door 16 of a garage 12 may entail detecting an open condition of the garage door 16 using a sensor 24, such as an optical, mechanical or other type of sensor, within the garage 12, transmitting a garage door open signal from the sensor 24 to a communication unit 20 in the garage, transmitting an alert signal (e.g. door open alert signal) from the communication unit 20 in the garage to a control module 26 within a vehicle 14, determining a level of ambient light from an ambient light sensor 30, transmitting a signal from the ambient light sensor 30 to the control module 26 indicative of the level of ambient light, transmitting a door close signal from the control module 26 to the transmitter 28 in the vehicle 14, transmitting the door close signal from the transmitter 28 in the vehicle to the communication unit 20 in the garage 12, and closing the garage door with a motor 22 upon the garage door actuation module 18 receiving the close door signal. Continuing, before transmitting the door close signal from the control module 26 in the vehicle 14 to a transmitter 28 in the vehicle, the method may further entail determining, with a clock 32 or time related device 32, (a) whether a current time of day is during daylight hours or non-daylight hours, (b) if an amount of time since the garage door was last opened has passed or been exceeded, and/or (c) whether an amount of time since the transmitter 28 last sent a garage door close signal to the communication unit 20 is within a predetermined time range or greater then a threshold time limit or time period. The decision that the control module 26 makes (e.g. whether or not to send the signal to close the garage door 16) may be dependent on the foregoing time periods or ambient light levels.

Another feature of the method of controlling a garage door 16 may entail programming the control module 26, via a user input module 34 within the vehicle 14, to customize the predetermined time ranges, time periods and/or threshold times. The user input module 34 may be equipped with a key pad to facilitate user programming. The user input module 34 permits customizing when and under what criteria (e.g. ambient light level or time related) the garage door 16 is closed.

The description of the present disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A method of controlling a garage door of a garage, the method comprising:
detecting an open condition of the garage door using a garage door actuation module;
transmitting an alert signal from the garage door actuation module within the garage to a garage door control system within a vehicle;
transmitting a signal from the garage door control system within the vehicle to the garage door actuation module; and
closing the garage door upon the garage door actuation module receiving the close door signal.

2. The method of claim 1, wherein detecting an open condition of the garage door further comprises detecting the open condition with an optical sensor.

3. The method of claim 1, wherein transmitting a signal from the garage door control system within the vehicle to the garage door actuation module within the garage further comprises:
sensing an outside ambient light level with an ambient light sensor within the vehicle; and
determining that the ambient light level is less than a threshold level before transmitting a signal from the garage door control system within the vehicle to the garage door actuation module.

4. The method of claim 1, wherein transmitting a signal from the garage door control system within the vehicle to the garage door actuation module within the garage further comprises:
determining that a time of day is within a predetermined range of times before transmitting a signal from the garage door control system within the vehicle to the garage door actuation module.

5. The method of claim 1, further comprising:
controlling a user input module, via human programming, within the vehicle to prevent control of the garage door control system within a vehicle.

6. The method of claim 1, wherein before closing the garage door upon the garage door actuation module receiving the close door signal, determining whether an elapsed time since the garage door was last opened is within a predetermined time range.

7. A method of controlling a garage door of a garage, the method comprising:
detecting an open condition of the garage door using a sensor to detect the open condition;
transmitting a first signal of the open condition of the garage door to a communication unit in the garage;
transmitting a door open signal from the communication unit in the garage to a control module in a vehicle;
transmitting the door close signal from a control module in the vehicle to a transmitter in the vehicle;
transmitting the close door signal from the transmitter in the vehicle to the communication unit in the garage; and
closing the garage door with a motor in the garage.

8. The method of claim 7, wherein before transmitting the door close signal from the control module in the vehicle to a transmitter in the vehicle, the method further comprising:
determining, with an ambient light sensor in the vehicle, whether an ambient level outside of the vehicle is below a predetermined light level.

9. The method of claim 7, wherein before transmitting the door close signal from the control module in the vehicle to a transmitter in the vehicle, the method further comprising:
determining, with a clock, whether a current time of day is during daylight hours or non-daylight hours.

10. The method of claim 7, wherein before transmitting the door close signal from the control module in the vehicle to a transmitter in the vehicle, the method further comprising:
determining, with a clock, an amount of time since the garage door was last opened.

11. The method of claim 7, wherein before transmitting the door close signal from the control module in the vehicle to a transmitter in the vehicle, the method further comprising:
determining, with a clock, whether an amount of time since the transmitter last sent a garage door close signal to the communication unit is within a predetermined time range.

12. The method of claim 7, further comprising:
controlling a user input module, via human programming, within the vehicle to customize control of the control module within the vehicle.

13. A method of controlling a garage door of a garage, the method comprising:
detecting an open condition of the garage door using a sensor within the garage;
transmitting a garage door open signal from the sensor to a communication unit in the garage;
transmitting an alert signal from the communication unit in the garage to a control module within a vehicle;
determining a level of ambient light from an ambient light sensor;
transmitting a signal from the ambient light sensor to the control module indicative of the level of ambient light;
transmitting a door close signal from the control module to the transmitter in the vehicle;
transmitting the door close signal from the transmitter in the vehicle to the communication unit in the garage; and
closing the garage door with a motor upon the garage door actuation module receiving the close door signal.

14. The method of claim 13, wherein before transmitting the door close signal from the control module in the vehicle to a transmitter in the vehicle, the method further comprising:
determining, with a clock, whether a current time of day is during daylight hours or non-daylight hours.

15. The method of claim 13, wherein before transmitting the door close signal from the control module in the vehicle to a transmitter in the vehicle, the method further comprising:
determining, with a clock, an amount of time since the garage door was last opened.

16. The method of claim 13, wherein before transmitting the door close signal from the control module in the vehicle to a transmitter in the vehicle, the method further comprising:
determining, with a clock, whether an amount of time since the transmitter last sent a garage door close signal to the communication unit is within a predetermined time range.

17. The method of claim 16, further comprising:
programming the control module, via a user input module within the vehicle, to customize the predetermined time range.
